(19) United States
(12) Patent Application Publication
(10) Pub. No.: US 2020/0170439 A1
(43) Pub. Date: Jun. 4, 2020

(54) BAIN-MARIES AND COLD TABLE PAN AND PAN LINER SYSTEM

(71) Applicant: Raymond Hoffman Wiley, Xenia, OH (US)

(72) Inventor: Raymond Hoffman Wiley, Xenia, OH (US)

(21) Appl. No.: 16/683,767

(22) Filed: Nov. 14, 2019

Related U.S. Application Data
(60) Provisional application No. 62/774,215, filed on Dec. 1, 2018.

(51) Int. Cl. A47J 27/14; A47J 36/24; B65D 71/70; B65D 81/18

(52) U.S. Cl. CPC A47J 27/14; B65D 81/18; B65D 71/70; A47J 36/24

(57) ABSTRACT

A bain-marie's and cold tables pan and pan liner system includes a temperature controlled food serving bar having at least one channel preferably a thermally controlled. A sub-pan is received in the channel and has a bottom, and an upward extending side wall which terminates in a lateral extending flange and defines generally upper sub-pan surfaces and lower sub-pan surfaces wherein the one sub-pan is made of a material and predefined thickness x sufficient to provide structural stability when disposed in the thermally controlled environment. A pan liner has a complementary configuration to the sub-pan having a bottom, and an upward extending side wall which terminates in a lateral extending flange and nested on the sub-pan and covers the upper sub-pan surfaces and having thickness x-y which is thinner than the sub-pan thickness x and made of a recyclable material.

### BACKGROUND OF THE INVENTION

### Field of Invention

This invention relates generally to the food service industry and more particularly a food serving bar which use pans to hold food, wherein the pans are held in what is commonly known as “cold tables” and “hot tables”. The tables are sometimes called bain-maries, steam tables, sandwich tables, pizza tables, make tables, salad bars and a variety of similar names. Such tables hold pans which are commonly referred to as bain pans, hotel pans, food pans, and other similar names. The instant invention is designed to replace and/or work with the existing equipment including a temperature controlled food serving bar for heating or cooling food products held in food-holding pans in the food serving bar.

### Prior Art

An exemplary hot/cold food serving bar frequently used in the fast food service industry, commonly referred to as a steam table or bain-marie in conjunction with cold table includes placing rows of food-holding pans in or above a bath of heated water to maintain food held in the food-holding pans at a desired temperature. This existing design is relatively inefficient. The heated bath of water must be maintained at an elevated temperature which requires a large amount of power to heat the water which, in turn, is used to heat the food-holding pans and results in increased humidity and temperature of the operating environment surrounding the table as a result of the steam generated by heating the water bath. The pans often have baked on food as a result of the heat and increased humidity of the surrounding environment which requires significant cleaning of the pans as well as the table. Due to various food and beverage inspector requirements, these pans must be cleaned after each use and relabeled with an inspection sticker per industry standards. If pans are not washed properly (which requires a four step system—wash, rinse, sanitize and air dry), especially raw meat pans, as this can result in micro-particles remaining present after washing, resulting in a risk of food borne illness originating from rotten food particles. Further, label requirements for existing food pans are expensive and the process is time consuming to take off and reapply to pans after they are cleaned. Even with cleaning, these pans can appear unclean due to the grease residue which adheres and remains even after cleaning. To the restaurant and consumer this is not desirable.

Therefore, a need exists for a food serving bar that effectively and efficiently holds food products, and provides for reduced cost of operation, eases cleaning requirements, enhances appearance and provides an improved serving experience. The present invention overcomes the deficiencies of the prior bain-marie pan arrangements, decreases cost and increases efficiencies of these systems.

### SUMMARY OF THE INVENTION

It is an object to increase efficiency of bain-marie and cold table systems.

It is a further object to decrease the cost of operation of bain-marie and cold table systems.

It is another object to provide an improved bain-marie and cold table system.

Still another object is to provide a bain-marie's and cold tables pan and pan liner system.

Yet another object is to do away with the need for relabeling each sub pan after each use.

Accordingly, the instant invention is directed to a bain-marie's and cold tables pan and pan liner system. The system includes a temperature controlled food serving bar having at least one channel with a thermally controlled environment extending lengthwise of the food serving bar. At least one sub-pan is received in the channel and has a bottom, and an upward extending side wall which terminates in a lateral extending flange and defines generally upper sub-pan surfaces and lower sub-pan surfaces wherein the one sub-pan is made of a material and predefined thickness x sufficient to provide structural stability when disposed in the thermally controlled environment. At least one pan liner is provided with the sub-pan having a complementary configuration to the sub-pan having a bottom, and an upward extending side wall which terminates in a lateral extending flange and nested on the sub-pan and covers the upper sub-pan surfaces and having thickness x-y which is thinner than the sub-pan thickness x and made of a recyclable material. Preferably, the one pan liner is of a translucent material. Another aspect of the invention is to provide the sub-pan comprised of a different color, such that the preparer only uses a predetermined color pan with a predetermined kind of food. For example, a color code system can be employed to avoid cross-contamination food groups: raw fish (blue), raw vegetables (green), raw beef (red) or raw chicken (yellow), etc.

The at least one channel typically defines an elongate pan-receiving cavity extending lengthwise of the food serving bar for placement of the at least one or more sub-pan/pan liner combination in the cavity. The at least one channel preferably includes a plurality of separate channel sections disposed in end-to-end relationship. The channel sections can be the same or different temperatures along a length of the channel. Adjacent channel sections can be include a thermal wall and a temperature control system can be provided for temperature control in separate channel sections such that food products can be held at different temperatures as understood in the art, e.g., a food serving bar in the fast food service industry to maintain separate ingredients (e.g., meat, rice, beans, lettuce, tomato, cheese etc.) at a desired temperature prior to making the end food item.

Other objects and features of the present invention will be in part apparent and in part pointed out hereinafter.

### BRIEF DESCRIPTION OF THE DRAWINGS

FIG. 1 is an exploded view of a first type of pan liner over a sub-pan;

FIG. 2 is an exploded view of a second type of pan liner over a sub-pan;

FIG. 3 is a view of the showing a sub-pan and pan liner for the food serving bar in a storage mode;

FIG. 4 depicts a sub-pan having pan liner therein being prepared for storage mode; and

FIG. 5 is a perspective of a bain-marie's and cold table with sub-pan and pan liner system of the present invention.

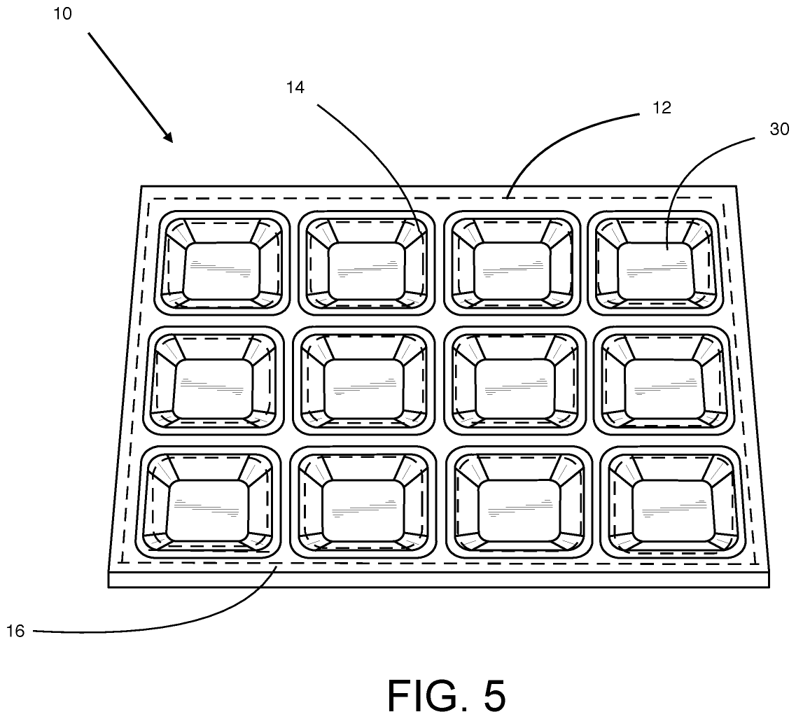

### DETAILED DESCRIPTION

Referring now to the drawings, a bain-marie's and cold tables pan and pan liner system of the present invention is designated by the reference numeral 10. The system 10 includes a temperature controlled food serving bar 12 having channels 14 with a thermally controlled environments extending lengthwise of the food serving bar 12.

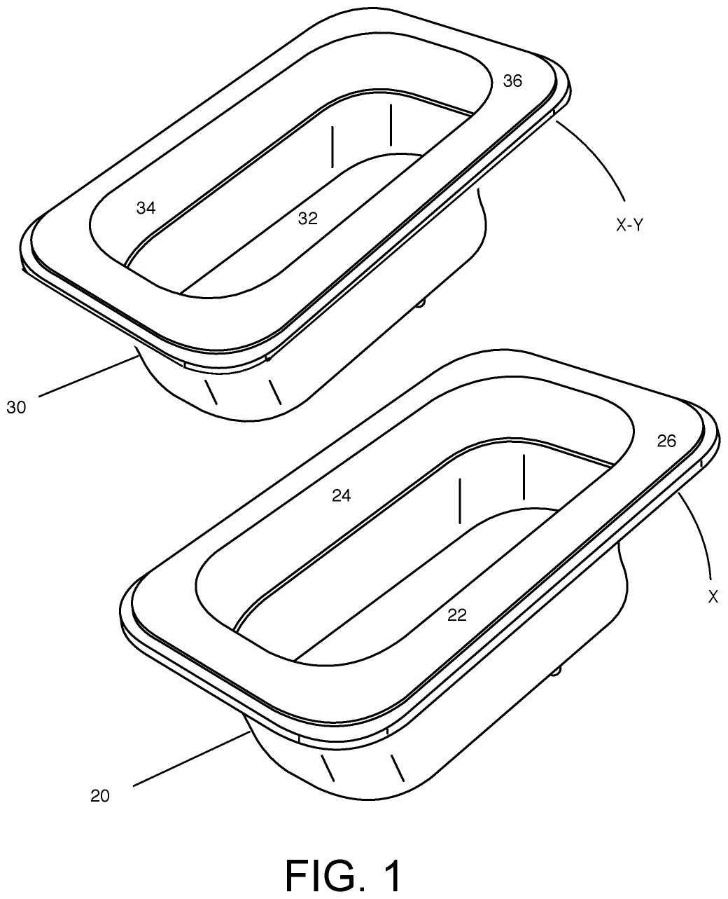

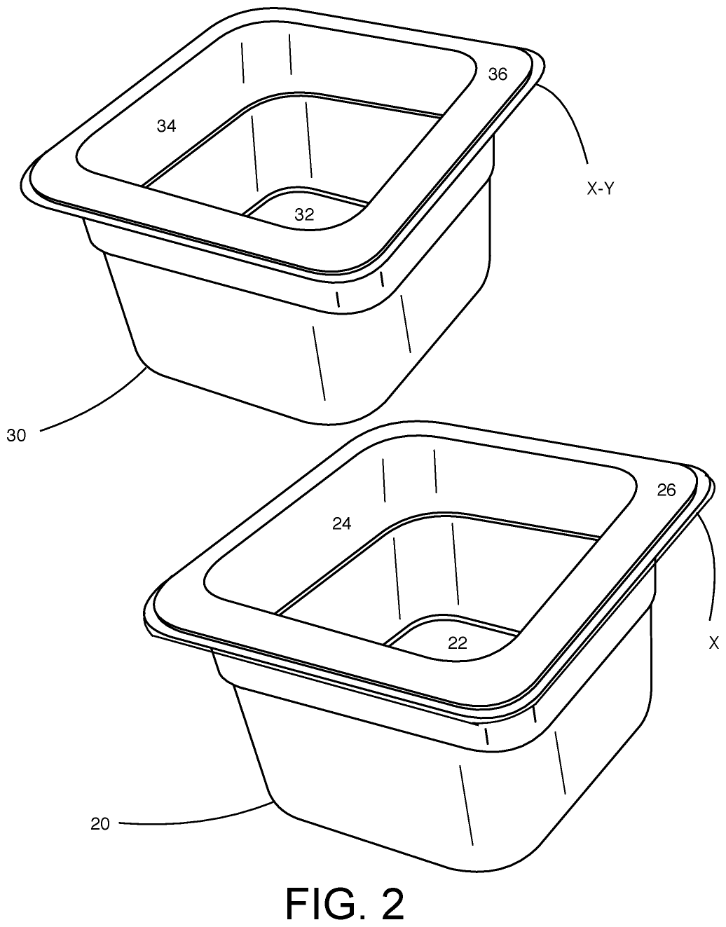

FIG. 1 and FIG.2 depict sub-pan 20 and pan liner 30. Like numerals refer to like parts with the difference being geometric shape.

A plurality of sub-pans 20 can be received in the channel 14. Each sub-pan 20 has a bottom 22, an upward extending side wall 24 which terminates in a lateral extending flange 26 and defines generally upper sub-pan surfaces and lower sub-pan surfaces. The sub-pans 20 can be a desired geometric shape, such as square or rectangular, and made of a material and predefined thickness x sufficient to provide structural stability when disposed in the thermally controlled environment, such as extreme heat or cold. The thickness x can be for example, about 62.5 mil. Depending on hot or cold application and method of making, for example, thermal forming, vacuum forming or injection molding the material can vary. Also, the intended use will also play a role in selection of material, such as hot table vs cold table applications. Additionally, supply and market price variations can affect the material used. Some suitable materials include polypropylene for products above 130 degrees (hot table pans and liners), Polyethylene terephthalate for cold products, polylactic acid may be used for cold applications, polylactide aliphatic copolymer might also be used for a higher temp option as well.

Each sub pan 20 includes a pan liner 30 having a complementary configuration to the respective sub-pan 20. Each pan liner 30 has a bottom 32, and an upward extending side wall 34 which terminates in a lateral extending flange 36 and can be nested on the sub-pan 20 and covers the upper sub-pan surfaces.

The pan liner 30 has a thickness x-y which is thinner than the sub-pan thickness x and made of a recyclable material. The thickness x-y can be for example, about 8.5 mil. Preferably, the pan liner 30 can be a translucent material. Another aspect of the invention is to provide the sub-pan 20 comprised of a different color, such that the preparer only uses a predetermined color pan with a predetermined kind of food. For example, a color code system can be employed to avoid cross-contamination food groups: raw fish (blue), raw vegetables (green), raw beef (red) or raw chicken (yellow). etc. The current restaurant industry uses three different pan options, pan sizes—, 1/9th, ⅙th , ⅓rd, ½ and whole pans, with a pan depth of 4″ and 6″. Currently, industry colors and material are temperature specific, such as stainless and amber for hot applications, and black and clear for cold food applications.

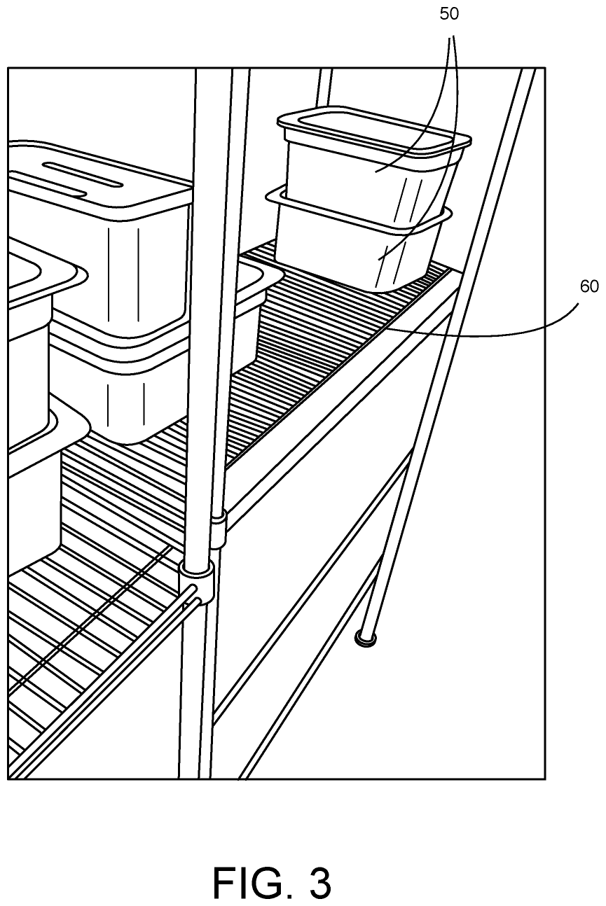

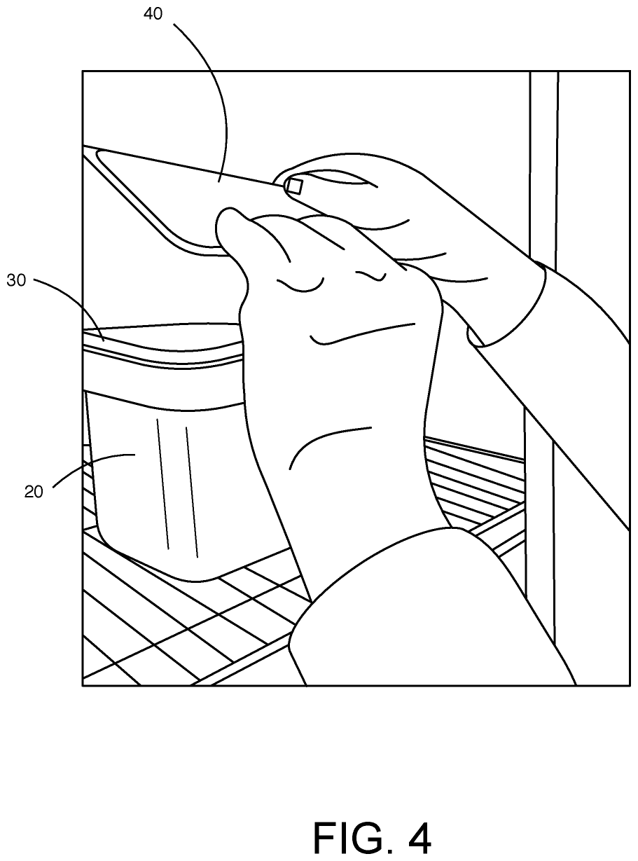

As depicted in FIG. 3 and FIG.4, the user can prepare food items by inserting a pan liner 30 inside the sub-pan 20. Food items can be placed inside the pan liner 20. A lid 40 is disposed on the pan liner 30 enclosing the same providing a prepped item 50. The prepared combination sub-pan 20, pan liner 30, lid 40 having food items therein can be stacked and stored on a shelf 60 in a refrigerated room as seen in FIG. 4. Further, since the pan-liner is disposable, the expensive removable labeling previously used in the industry can be done away with.

The channel(s)14 typically defines an elongate pan-receiving cavity 18 extending lengthwise of the food serving bar 12 for placement of one or more sub-pan/pan liner 20/30 combination in the cavity 18. The channel(s) 14 preferably includes a plurality of separate channel sections 19 disposed in end-to-end relationship. The channel sections 19 can be the same or different temperatures along a length of the channel 18. Adjacent channel sections 19 can be include a thermal wall and a temperature control system can be provided for temperature control in separate channel sections 19 such that food products can be held at different temperatures as understood in the art, e.g., a food serving bar 12 in the fast food service industry to maintain separate ingredients (e.g., meat, rice, beans, lettuce, tomato, cheese etc.) at a desired temperature prior to making the end food item.

The food serving bar 12 is particularly useful in heating food products (not shown) held in sub-pan/pan liner 20/30 combination in the serving bar 12. By so providing the sub-pans 20 and pan liners 30 there is increased efficiency and lower cost. Further, there is less risk of food borne illness. The invention offers a new “twist” in the restaurant food bar pan industry. Food safety is increased by use of the invention where an inexpensive recyclable pan liner 30 removes the need for additional labor in washing and labeling requirements for restaurants in food safety. Prior hereto, if pans are not washed properly (which requires a four step system—washing, rinsing, sanitizing and air drying), this can result in micro-particles remaining present after washing, resulting in a risk of food borne illness originating from rotten food particles, which can commonly happen with raw meat pans.

The instant invention sub-pan 20 and pan liner 30 combination provides a disposable pan or pan insert/liner which saves labor dollars, promotes safer food to serve and a visually more aesthetically pleasing appearance to the consumer. Additionally, with the growing food-truck and catering industry (which does not have on-board pan washing stations), the instant invention system 10 provides a unique and appealing way to meet all the current regulations and help insure safe serving situations.

Finally, the instant invention enables restaurants a unique way to choose from variety of colors for their pans which will enhance the look of the food in the holding tables. This is especially helpful in fast casual restaurants such as Hot Head Burritos®, Subway®, Chipotle®, and others, where the customers look directly into food pans as employees make entrees. For example, a bright green pan can enhance the looks of red peppers or a yellow pan might be used for green peppers. The food industry also uses a color code system of its own when it comes to quickly identifying different cross-contamination food groups: raw fish (blue), raw vegetables (green), raw beef (red) or raw chicken (yellow). The instant invention optional colors also work in conjunction with the raw food identification system. It is contemplated that the pan liner 30 could also be a color which complements the sub-pan.

While the present invention has been illustrated by a description of one or more embodiments and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A bain-marie's and cold tables pan and pan liner system, which includes:
a temperature controlled food serving bar having at least one channel with a thermally controlled environment extending lengthwise of said food serving bar;
at least one sub-pan is received in said channel, said sub-pan having a bottom, and an upward extending side wall which terminates in a lateral extending flange and having an upper sub-pan surface and a lower sub-pan surface wherein said at least one sub-pan is made of a material and had predefined thickness X sufficient to provide structural stability when disposed in the thermally controlled environment; and
at least one pan liner disposed in said at least one sub-pan, said pen liner having a complementary configuration to said sub-pan and having a bottom, and an upward extending side wall which terminates in a lateral extending flange, said pan line nests in said at least one sub-pan and covers said upper sub-pan surface and has thickness X-Y which is thinner than said sub-pan thickness X and is made of a recyclable material.

2. The bain-marie's and cold tables pan and pan liner system of claim 1, wherein said at least one pan liner is made of a translucent material.

3. The bain-marie's and cold tables pan and pan liner system of claim 1, which includes a plurality of sub-pans and wherein at least two of said sub-pan are comprised of a different color.

4. The bain-marie's and cold tables pan and pan liner system of claim 3, wherein at three said sub-pans include a distinct color associated with a predetermined food ingredient to avoid cross-contamination food groups.

5. The bain-marie's and cold tables pan and pan liner system of claim 4, wherein a first color sub-pan is blue, a second said color cub-pan is green, and a third sub-pan is red or and a fourth sub-pen is yellow.

6. The bain-marie's and cold tables pan and pan liner system of claim 1, wherein at least one channel defines an elongate pan-receiving cavity extending lengthwise of said food serving bar for placement of said at least one or more sub-pan/pan liner combination in said cavity.

7. The bain-marie's and cold tables pan and pan liner system of claim 6, wherein said at least one channel includes a plurality of separate channel sections disposed in end-to-end relationship.

8. The bain-marie's and cold tables pan and pan liner system of claim 7, wherein said channel sections are one of same and different temperatures along a length of said channel.

9. The bain-marie's and cold tables pan and pan liner system of claim 7, wherein adjacent channel sections include a thermal wall and a temperature control system separately controls temperature in each separate channel sections such that food products can be held at different temperatures.
